(19) United States
(12) Patent Application Publication
(10) Pub. No.: US 2010/0117930 A1
(43) Pub. Date: May 13, 2010

(54) HEADS-UP VISUALIZATION DEVICE FOR AIRCRAFT COMPRISING MEANS OF DISPLAYING A SYMBOLOGY DEDICATED TO OBSTACLE AVOIDANCE

(76) Inventors: Corinne Bacabara, Le Haillan (FR); Christian Nouvel, Merignac (FR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/597,957

(22) PCT Filed: May 21, 2008
(86) PCT No.: PCT/EP08/56286

§ 371 Date: Oct. 28, 2009

(30) Foreign Application Priority Data
May 25, 2007 (FR) 0703736

(51) Int. Cl. G09G 5/00

(52) U.S. Cl. 345/7

(57) ABSTRACT

The general field of the invention is, within the framework of terrain anti-collision systems for aircraft, the presentation in the Head-Up sight of a simplified symbology suited to these critical situations. It essentially comprises two identical vertical parallel bars of angular dimension substantially equal to the vertical angular field of the Head-Up visualization device, the positions of said bars in the horizontal plane being representative of the limits of the aircraft's clearance path and a horizontal bar disposed between the two vertical parallel bars so as to form an H, the position in the vertical plane of said horizontal bar being representative of the floor altitude that must be maintained by the aircraft. Other symbols supplement this piloting aid symbology.

### CROSS-REFERENCE TO RELATED APPLICATIONS

The present Application is based on International Application No. PCT/EP2008/056286, filed on May 21, 2008, which in turn corresponds to French Application No. 0703736, filed on May 25, 2007, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of flight management systems for aircraft comprising a terrain anti-collision system and a collimated visualization device able to present symbologies dedicated to the avoidance of obstacles.

2. Background of the Prior Art

In the aeronautical field, collisions with the ground without loss of control, commonly called CFITs, the acronym standing for “Controlled Flight Into Terrain” are the prime cause of catastrophic accidents to civilian airplanes. The aeronautical industry is concentrating its efforts on means for reducing and ultimately eliminating all future CFIT accidents.

For thirty years now, to solve this problem, the aeronautical industry has been developing a tool called GPWS standing for “Ground Proximity Warning System”. However, GPWS has no systems for recognizing the situation of the terrain and does not know the relative trajectory of the airplane with respect to the terrain. The ever growing increase in air traffic has given rise to a new growth of CFITs despite the quasi-generalized use of GPWS. Today, CFITs still represent more than 40% of accidents.

The technological advances obtained notably in the development of digitized terrain files, in precision of positioning by virtue of GPS location and in increased processing power have allowed the development of new concepts making it possible to guard against these risks of collision with the ground. These concepts rely essentially on extrapolation of the current trajectory of the airplane and on a terrain database corresponding to the relief overflown making it possible to predict these risks. These concepts are materialized in the form of a new generation of equipment intended for transport or business planes called TAWS for Terrain Awareness and Warning System. This system is, for example, marketed by the company THALES AVIONICS under the brand name GCAM standing for Ground Collision Avoidance Module.

The GCAM system is described in FIG. 1. It essentially comprises a central electronic computer linked on the one hand to the network of sensors and pick-ups of the aircraft and on the other hand, to the various displays of the instrument panel as well as to the audible alarms disposed in the cockpit by means of a data transmission bus. The sensors are essentially pick-ups making it possible to determine the position of the craft with respect to the ground, its attitude and its speed. The displays concerned are the Head-Up sight as well as the Head-Down piloting and navigation screens such as the “Navigation Display” and the “Primary Flight Displays”, screens denoted HUD, ND and PFD in FIG. 1.

The dynamic operation of the GCAM is as follows. It monitors the geographical environment of the aircraft. If it finds that there is no risk of terrain threat, near or far, the depictions presented to the pilot and optionally to the copilot are standard and representative of a mission of IFR type, the acronym standing for Instrument Flight Rules or VFR type, the acronym standing for Visual Flight Rules. The system is in a mode termed “NORMAL”.

When the system determines that there is a possibility of dangerous terrain along the axis of the aircraft and/or laterally, the system passes to a mode termed “LATERAL PROXIMITY”. In this mode, the depictions must allow the pilot to carry out the navigation tasks and to comprehend the situation without ambiguity. The distance from the aircraft to the obstacles is of the order of forty Nautical Miles.

In this case, if the pilot does not react, the airplane approaches dangerously close to the terrain, its trajectory touching the relief. As soon as the time before the collision becomes less than about twelve seconds, the system passes to a mode termed “CAUTION”. The audible alarm “TERRAIN TERRAIN” sounds. Alarm messages are also displayed on the screens.

The pilot has understood the situation. He must now act by piloting manually. When he has only about eight seconds left to perform a correct avoidance maneuver, the system passes to a mode termed “WARNING”. The proposed avoidance maneuver is either vertical of the type “PULL-UP” or involves a turn of the type “PULL UP—TURN RIGHT” or “PULL UP—TURN LEFT”. The audible alarms sound. The alarm messages are also displayed on the screens.

The situation reverts to usual. The obstacle is avoided. The system passes back to the “NORMAL” mode or to the “LATERAL PROXIMITY” mode if it remains in the vicinity of potentially dangerous terrains. The audible alarm “CLEAR OF TERRAIN” sounds. This return to normal is accompanied by a return to a conventional display in the customary operating modes.

The GCAM allows notably the generation of a specific audible alarm or “warning” called “Avoid Terrain” in addition to the conventional “warning” called “Pull Up” which corresponds to a vertical avoidance maneuver. This alarm is engaged when an avoidance maneuver by “Pull-Up” no longer makes it possible to ensure a clearance without collision. The “Avoid Terrain” alarm of the GCAM, though representing a significant advance, does not completely meet pilot expectations. They would like to have an indication of lateral avoidance maneuver when no vertical avoidance maneuver is possible any longer.

During the avoidance maneuvers, the pilot must essentially navigate and pilot his machine manually in the vertical and horizontal planes. These tasks are detailed below:
Navigating:
   Identifying/Grading the dangerous obstacles;
   Analyzing the situation to protect oneself from threats;
   Comprehending the new trajectories proposed by the system.
Piloting the machine in the vertical plane:
   Maintaining attention on the current vertical speed;
   Maintaining attention on the current altitude;
   Maintaining attention on the proximity of the ground;
   Being aware of the attitude of the airplane with respect to the real world;
   Maintaining attention on the speed vector of the airplane;
   Maintaining attention on the angle of attack so as to avoid stalling;
   Maintaining a climb slope.
Piloting the machine in the horizontal plane:
   Maintaining attention on the current course followed by the airplane;
   Maintaining attention on the current roll of the airplane;
   Entering a turn correctly;
   Holding a turn correctly;
   Exiting a turn correctly;
   Maintaining a correct trajectory with respect to a predefined avoidance trajectory.

When the aircraft has a Head-Up sight, the latter conventionally displays information relating to piloting or navigation. In a Head-Up sight, this information is collimated at infinity and projected superimposed on the exterior landscape. An example of depictions of this type is represented in FIG. 2. Conventionally the figure includes, on the right an altitude scale in feet, on the left a speed scale in knots, at the center, the horizon, the flight director and at the bottom the heading rose with the indication of the path to be followed. As seen, this figure comprises a large number of symbols which vary constantly as a function of the position of the craft. In “NORMAL” mode, this symbology is perfectly suited to piloting and to navigation. However, if a possibility of collision arises, it may turn out to be too complex to allow the pilot to make the maneuvers indispensable to the survival of the craft.

### SUMMARY OF THE INVENTION

The object of the invention is to present, in the Head-Up sight, a simplified ergonomic symbology making it possible:
To improve the perception by the crew of their situation in relation to the terrain;
To elucidate the possible avoidance maneuvers;
To make available to the pilot the guidance information necessary for executing a lateral avoidance maneuver when no vertical avoidance maneuver of “Pull-Up” type is possible any longer. This maneuver is carried out under manual piloting.

The information necessary for generating this symbology arises from the calculation algorithms developed within the framework of the functionalities implemented in the GCAM system. These algorithms make it possible to calculate the information necessary in order to present in real time the information on the Head-Up sight.

More precisely, the subject of the invention is a so-called Head-Up or HUD visualization device for aircraft comprising means for generating, for collimating and for superimposing symbols on the exterior landscape which are intended to aid the piloting of the aircraft in the horizontal and vertical planes, characterized in that the symbols are at least two identical vertical parallel bars of angular dimension substantially equal to the vertical angular field of the Head-Up visualization device, the positions of the bars in the horizontal plane being representative of the limits of the aircraft's clearance path.

Advantageously, a horizontal bar is disposed between the two vertical parallel bars so as to form an H, the position in the vertical plane of the horizontal bar being representative of the floor altitude that must be maintained by the aircraft.

Advantageously, when the limits of the aircraft's clearance path are situated in the angular field of the Head-Up visualization device, the bars are represented as solid lines, when the limits of the aircraft's clearance path are situated outside the angular field of the Head-Up visualization device, the bars are represented as dashed lines.

Advantageously, the angular distance separating the two parallel bars is about five degrees and each bar is symbolized by two parallel lines about a milliradian apart, the value of the floor altitude being indicated at the level of the horizontal bar.

Advantageously, a horizontal or vertical arrow disposed along the axis of the Head-Up visualization device indicates the direction of the maneuver to be performed, the arrow flashing as long as the maneuver to be performed is in progress.

Advantageously, the symbol representing the speed vector comprises two indications representing respectively the percentages of the maximum possible thrusts of the jets situated on the left and on the right of the aircraft.

Advantageously, the values of the load factor experienced by the aircraft and of the angle of attack are also displayed and when the authorized limits of the values are attained, the latter are presented enclosed.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents the general schematic of a GCAM system;

FIG. 2 represents a conventional symbology of head-up sight according to the prior art;

FIGS. 3 to 5 represent the symbology according to the invention in various flight configurations.

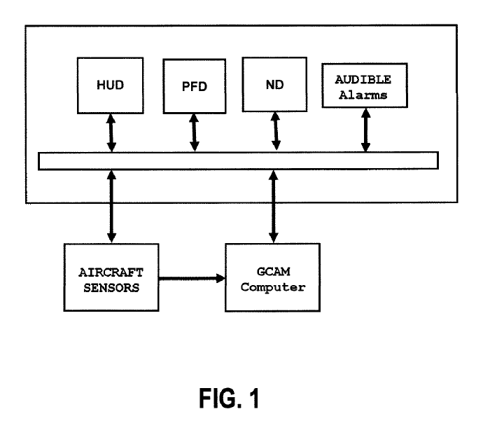

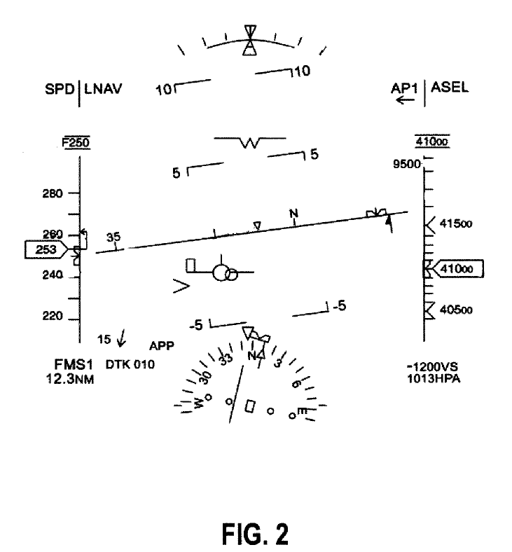

### DETAILED DESCRIPTION OF THE INVENTION

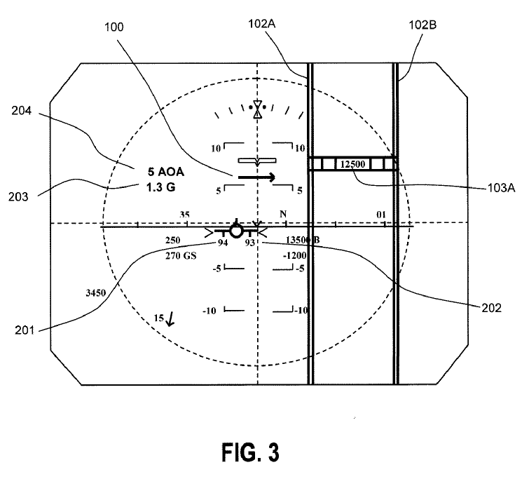

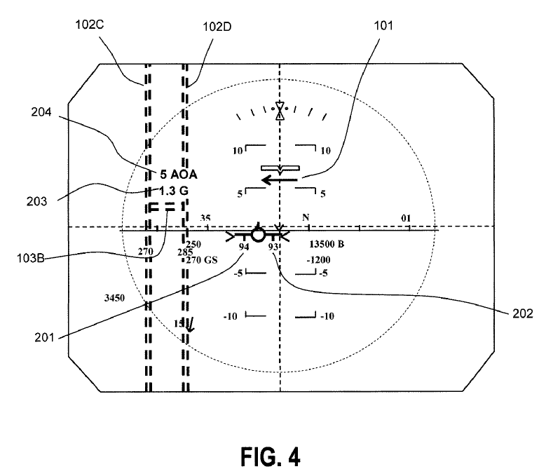

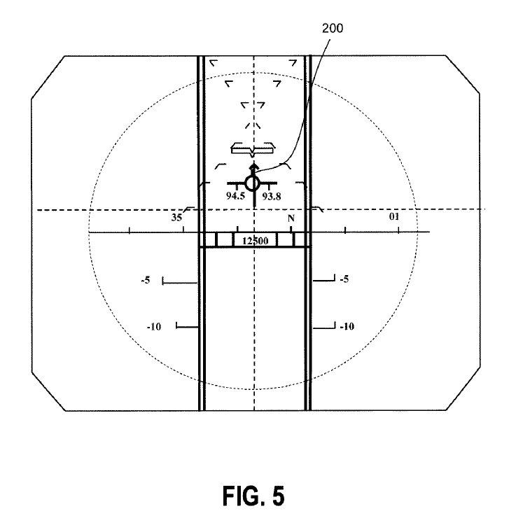

By way of nonlimiting examples, the new plainer symbology according to the invention is represented in FIGS. 3, 4 and 5. It is represented such as seen by the pilot. FIGS. 3 and 4 represent the symbology in the “LATERAL PROXIMITY” or “CAUTION” modes, FIG. 5 represents the symbology in the “WARNING” mode. The new symbols according to the invention are represented as bold lines. The limits of the field of the sight are represented by a rectangle with clipped corners.

This symbology essentially comprises symbols enabling the pilot to pilot the craft in the horizontal and vertical planes.

The symbols for aiding piloting in the horizontal plane are:
Clearance path position symbols;
Right or left turn command symbols.

The symbols for aiding piloting in the vertical plane are:
A floor altitude symbol;
A climb command symbol;
Engine thrust symbols;
A load factor symbol;
An angle of attack symbol.

These symbols are detailed below.

The clearance path position symbol indicates where the advocated turn sector is situated with respect to the axis of the airplane. It is symbolized by two parallel vertical bars or posts occupying almost the entire vertical visual field of the Head-Up sight. These lines are represented under the references 102A, 102B, 102C, 102D in FIGS. 3 to 5. Preferably, the minimum deviation in heading between the two posts is five degrees so as to allow good readability and good piloting performance. Each bar can be represented by two closely-spaced parallel lines. The deviation between the two lines of a bar is, in this case, a milliradian. When the turn sector lies in the field of the sight, as indicated in FIGS. 3 and 5, the posts 102A and 102B are represented as solid lines, when the turn sector lies outside the field of the sight, as indicated in FIG. 4, the posts 102C and 102D are represented as dashed lines. When the airplane commences its turn, the posts translate horizontally and progressively regain the center of the field of the sight.

The right 100 or left 101 turn command symbols indicate the direction of the turn sector. They are represented by a horizontal straight arrow disposed along the sighting axis and whose direction indicates the direction of turn. They are represented under the references 100 and 101 in FIGS. 3 and 4. These symbols can flash as long as the turn has not terminated, the flashing period possibly being a second.

The floor altitude symbol indicates, in an angular manner, the position of the obstacle to be crossed with respect to the carrier. This symbol indicates in the sector defined by the clearance path position symbol the minimum crossing altitude provided by the GCAM system. It is symbolized by a horizontal bar situated between the previous posts and delimited by them. It is represented under the references 103A and 103B in FIGS. 3 to 5. When the altitude is provided by the GCAM system, it is given in feet with respect to mean sea level by a five-digit counter situated above the horizontal bar. If the value of the altitude is not provided, the horizontal bar then represents a minimum slope to be held. In dynamic terms, the horizontal bar accompanies the movement of the posts indicating the position of the clearance path and also translates in the vertical plane as a function of the variations of the floor altitude.

The climb command symbol indicates to the pilot that it is absolutely essential to climb, so-called pull-up maneuver. It is represented by a vertical straight arrow disposed along the sighting axis. It is represented in FIG. 5 under the reference 200. This symbol can flash as long as the climb has not terminated, the flashing period possibly being a second.

The left engine thrust symbols referenced 201 and 202 in FIGS. 3 to 5 represent the respective thrusts of the jets situated on the left and on the right of the craft. They are depicted by counters with three digits representing the percentage of the maximum possible thrust of the jets. These counters are disposed under the wings of the symbol representing the speed vector, conventionally represented by a circle extended by two horizontal lines and surmounted by a vertical line supposed to represent the craft. This information allows the pilot not to have to turn his head during the tricky avoidance maneuvers.

The load factor symbol referenced 203 in FIGS. 3 to 5 represents the current load factor experienced by the airplane. This item of information is important for conventional airplanes not protected by electric flight controls. It is represented by a counter with two digits, indicating the number of relative g's experienced by the craft. When the authorized airplane limit is attained, the value is enclosed.

The angle of attack symbol represents the current angle of attack of the airplane. It is referenced 204 in FIGS. 3 to 5. This item of information is also important for conventional airplanes not protected by electric flight controls. It is represented by a counter with two digits, indicating the angle in decimal degrees. When the authorized airplane limit is attained, the value is enclosed.

Piloting with the aid of this novel symbology is simple. In the case of an alert, the pilot must disconnect the automatic pilot and/or the auto-stick—fly by the speed vector and position it between the “rugby posts” determined by the two vertical bars of the clearance path position symbol and above the horizontal bar of the floor altitude—monitor in the HUD the angle of attack, the load factor, the trim, the roll and the rate of acceleration—monitor the thrust of the engines.

This symbology can be applied to a large number of aircraft. The types of aircraft concerned may equally well be rotary-wing or fixed-wing aircraft in meteorological conditions of VMC/IMC type, the acronyms standing for Visual Meteorological Conditions and Instrumental Meteorological Conditions and under flight rules of IFR/VFR type.

However, it applies most particularly to commercial aviation with passenger transports and to cargo planes in cruising flight conditions with departure and arrival at appropriately kitted out aerodromes with a sufficient altitude above the obstacles or one that is low with respect to the surrounding natural obstacles. It also applies to special civilian security or fire missions in low-altitude flight conditions with departure and arrival at appropriately kitted out aerodromes as well as at makeshift airfields.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A so-called Head-Up or HUD visualization device for aircraft comprising means for generating, for collimating and for superimposing symbols on the exterior landscape which are intended to aid the piloting of the aircraft in the horizontal and vertical planes, wherein the symbols are at least two identical vertical parallel bars of angular dimension substantially equal to the vertical angular field of the Head-Up visualization device, the positions of said bars in the horizontal plane being representative of the limits of the aircraft's clearance path, a horizontal bar being disposed between the two vertical parallel bars so as to form an H, the position in the vertical plane of said horizontal bar being representative of the floor altitude that must be maintained by the aircraft.

2. The visualization device as claimed in claim 1, wherein, when the limits of the aircraft's clearance path are situated in the angular field of the Head-Up visualization device, the bars are represented as solid lines, when the limits of the aircraft's clearance path are situated outside the angular field of the Head-Up visualization device, the bars are represented as dashed lines.

3. The visualization device as claimed in claim 1, wherein the angular distance separating the two parallel bars (102A, 102B) is about five degrees and that each bar is symbolized by two parallel lines about a milliradian apart.

4. The visualization device as claimed in claim 1, wherein a value of the floor altitude is indicated at the level of the horizontal bar.

5. The visualization device as claimed in claim 1, wherein a horizontal or vertical arrow disposed along the axis of the Head-Up visualization device indicates the direction of the maneuver to be performed.

6. The visualization device as claimed in claim 5, wherein the arrow is flashing as long as the maneuver to be performed is in progress.

7. The visualization device as claimed in claim 1, wherein a symbol representing the speed vector comprises two indications representing respectively the percentages of the maximum possible thrusts of the jets situated on the left and on the right of the aircraft.

8. The visualization device as claimed in claim 1, wherein the values of the load factor experienced by the aircraft and of the angle of attack are also displayed.

9. The visualization device as claimed in claim 8, wherein, when the authorized limits of said values are attained, the latter are presented enclosed.
